(19) United States
(12) Patent Application Publication
(10) Pub. No.: US 2021/0035446 A1
(43) Pub. Date: Feb. 4, 2021

(54) MICRO-MOBILITY SHARING SERVICE SYSTEM BASED ON AUTHENTICATED USERS FROM CAR NUMBER IN PARKING LOT

(71) Applicant: waterbear capital Inc., Seoul (KR)

(72) Inventors: Kyungrae Kim, Seoul (KR); Seungho Lee, Seoul (KR)

(73) Assignee: waterbear capital Inc., Seoul (KR)

(21) Appl. No.: 16/906,773

(22) Filed: Jun. 19, 2020

(30) Foreign Application Priority Data
Jul. 30, 2019 (KR) 10-2019-0092402

(51) Int. Cl. G08G 1/065; G06K 9/00; G06Q 20/40; G06Q 10/02

(52) U.S. Cl. CPC G08G 1/065; G06Q 10/02; G06Q 20/401; G06K 9/00791

(57) ABSTRACT

A micro-mobility sharing service system includes an entering vehicle number recognition system including a first camera for photographing a license plate of an entering vehicle passing through an entering vehicle crossing gate of the parking lot and a number recognition module for recognizing a character among images taken by the first camera, a management server for receiving and storing entering vehicle number information recognized by the entering vehicle number recognition system, a rental server for receiving the entering vehicle number information from the management server and transmitting available micro-mobility information to a user terminal of the entering vehicle based on the entering vehicle number information; and a micro-mobility controller for transmitting information about a first micro-mobility selected by a user based on the received available micro-mobility information to the rental server and receiving uses authority information from the rental server received the first micro-mobility information.

### RELATED APPLICATIONS

The present application claims priority to Korean Application No. 10-2019-0092402, filed Jul. 30, 2019, of which is hereby incorporated in entirety by reference as set forth herein.

### TECHNICAL FIELD

The present disclosure relates to a micro-mobility sharing service system based on a user recognized by a vehicle number in a parking lot, and more particularly, to a service system that can share a micro-mobility existing in a parking lot based on a vehicle number recognized in a vehicle entering the parking lot.

### BACKGROUND

In the past, because vehicles were classified into expensive products, there were many households that did not hold the vehicle, and the overall number of vehicles was small, but recently, as the standard of living has increased, more families have one vehicle per household or more than two vehicles per household. Further, because companies hold company vehicles for work using a lease, a rental, etc., the number of vehicles has been increased compared to the past.

In the case of shopping malls and apartments built in the past, parking facilities are insufficient compared to the number of vehicles due to unpredictability of use of a large number of vehicles. Especially, in the case of downtown areas or old buildings where there are many business buildings, parking spaces are remarkably insufficient.

In order to secure more parking space, there is a method of more establishing a parking lot or remodeling a building, but in reality, it is difficult to solve the problem in a short time in terms of space, time, and cost, and recently, the number of top parking lots that can park vehicles while occupying a small area by building vertically is increasing. However, the top parking lot also has a problem in that because it also takes a long time in parking, a driver is reluctance to park, or parking is difficult due to a small space, or parking of a vehicle of a certain size is impossible.

Alternatively, when visitors visiting a particular place have difficulty in parking in a building thereof, they often pay for parking in other buildings in the vicinity and move to a building in a desired destination, and in this case, because visitors should walk a lot of distance, it is very uncomfortable due to a large amount of time and physical strength consumption.

Accordingly, there is a need for a system that enable visitors or residents to reduce unnecessary time, cost, and physical strength consumption while conveniently parking using various existing parking lots.

Recently, with the development of science and technology, the use of micro-mobility that may conveniently move even in a small size is increasing, and the number of companies providing a sharing service for the micro-mobility is gradually increasing. The sharing service is a service in which a consumer who wants to use the micro-mobility rents and pays a certain fee to use for a while when necessary without ownership by direct purchase of the micro-mobility, and recently, attempts on the sharing service have been increasing in many ways. In the case of a service provider, there was a lot of concern about the loss of the device, there were a lot of spatial restrictions on charging the battery from time to time, and there was a problem that a lot of effort should be put to recover the device.

Accordingly, there is a demand for a service that facilitates battery charging while increasing a recovery rate by reducing the concern of a device loss in the sharing service of the micro-mobility.

### SUMMARY

The present disclosure provides a service system for sharing a micro-mobility that can reduce unnecessary waste of time and physical strength while parking in a building around a destination building desired by a user only with existing parking lots without more establishment of the parking lot.

The present disclosure further provides a service system for sharing a micro-mobility that enable battery charging to be easier while reducing the concern of loss of a micro-mobility device by clear user authentication and increasing a recovery rate in the service for sharing the micro-mobility.

The present disclosure further provides a service system for enabling both users and share operators to conveniently operate and use the system with a convenient charging system in using micro-mobility and for sharing an optimized micro-mobility in a distance and a cost.

The object of the present disclosure is not limited to the above-described objects and the other objects will be understood by those skilled in the art from the following description.

In an aspect, a micro-mobility sharing service system located in a parking lot based on information of a vehicle entering the parking lot includes an entering vehicle number recognition system including a first camera for photographing a license plate of an entering vehicle passing through an entering vehicle crossing gate of the parking lot and a number recognition module for recognizing a character among images taken by the first camera; a management server for receiving and storing entering vehicle number information recognized by the entering vehicle number recognition system; a rental server for receiving the entering vehicle number information from the management server and transmitting available micro-mobility information to a user terminal of the entering vehicle based on the entering vehicle number information; and a micro-mobility controller for transmitting information about a first micro-mobility selected by a user based on the received available micro-mobility information to the rental server and receiving uses authority information from the rental server received the first micro-mobility information.

The micro-mobility sharing service system may further comprise a cost payment device, wherein the micro-mobility controller transmits use completion information to the rental server, when the user completes use of the first micro-mobility and returns the first micro-mobility, the rental server transmits use time information of the first micro-mobility to the management server, the management server generates first charging information in proportion to the received use time information and transmits the first charging information to the cost payment device, the cost payment device displays the transmitted first charging information, and the first charging information can be determined when the user inputs the entering vehicle number information.

The management server may generate second charging information for a use cost of the parking lot when the user inputs an exiting vehicle scheduled time and transmits third charging information obtained by adding the first charging information and the second charging information to the cost payment device, the cost payment device display the third charging information, and the third charging information can be determined when the user inputs the entering vehicle number information.

The micro-mobility sharing service system may further comprise an exiting vehicle number recognition system comprising a second camera for photographing a license plate of an exiting vehicle passing through an exiting vehicle crossing gate in the parking lot and a number recognition module for recognizing a character among images taken by the second camera, wherein exiting vehicle number information recognized by the exiting vehicle number recognition system is transmitted to the management server, the cost payment device transmits payment completion information comprising the entering vehicle number information to the management server, when cost payment for the third charging information is completed, and the management server transmits an open command of an exiting vehicle crossing gate to the exiting vehicle crossing gate, if the exiting vehicle number information and the entering vehicle number information of the payment completion information are matched.

When only one of the first charging information and the second charging information is paid, the cost payment device may transmit partial payment completion information comprising the entering vehicle number information to the management server, when the exiting vehicle number information and the entering vehicle number information of the partial payment completion information are matched, the management server may transmit an open command of the exiting vehicle crossing gate to the exiting vehicle crossing gate, and the partial payment completion information is stored at the management server, and when the partially paid vehicle uses a second parking lot, the first charging information is further charged at a first rate to generate first-1 charging information.

The micro-mobility sharing service system may further comprise a user information input device for enabling the user to input user information comprising vehicle number and phone number information, wherein the user information input device transmits the input user information to the rental server, and the rental server transmits available micro-mobility information to a user terminal of the entering vehicle based on the entered vehicle number information received from the management server and the input user information.

The micro-mobility sharing service system may further comprise a micro-mobility rental application installed in the user terminal in order to rent the micro-mobility, wherein the user inputs personal information comprising a user's name, phone number, and vehicle number to the micro-mobility rental application, and the personal information is transmitted to the management server, and the management server receives the recognized vehicle number information from the vehicle number recognition system and transmits authority information on whether to rent the micro-mobility to the user terminal based on the phone number of the vehicle number matched to the personal information.

The micro-mobility rental application may receive preference information comprising destination information, distance weight information, and cost weight information from the user and transmits the preference information to the management server, and the management server transmits micro-mobility rental possible information and parking lot information near the user's destination information to the micro-mobility rental application of the user terminal based on the preference information.

The management server may store parking fee information about a plurality of parking lots, and when the user inputs the preference information, a micro-mobility rental estimated time, and estimated parking time information, the management server transmits parking lot information near the user's destination information, estimated charging information, and micro-mobility rental possible information to the micro-mobility rental application based on the information.

The user may comprise a first user who rents a first micro-mobility and a second user who rents a second micro-mobility, when the first user inputs first movement information comprising first departure point information, first destination information, first departure scheduled time information, and first destination arrival scheduled time information to the micro-mobility rental application, the first movement information may be transmitted to the management server, when the second user inputs second mobility information comprising second departure point information, second destination information, second departure scheduled time information, and second destination arrival scheduled time information to the micro-mobility rental application, the second movement information may be transmitted to the management server, the management server may compare the first movement information and the second movement information, and transmits the first movement information to a user terminal of the second user and transmits the second movement information to a user terminal of the first user for exchange, when the first departure point information and the second destination information, and the first departure scheduled time information and the second destination arrival scheduled time information are matched or when the second departure point information and the first destination information and the second departure scheduled time information and the first destination arrival scheduled time information are matched, and when the first micro-mobility may be exchanged by the second user and the second micro-mobility is exchanged by the first user, the first user and the second user transmit exchange execution information to the management server through the micro-mobility rental application.

The management server may transmit the exchange execution information to the rental server.

The exchange execution information may comprise exchange time information in which exchange is performed, and when the exchange execution information is transmitted to the management server, charging information of the first user and the second user is changed based on the exchange time information.

The detailed matters of the embodiments will be included in the detailed description and the drawings.

According to embodiments of the present disclosure, at least following effects are obtained.

A micro-mobility sharing service system based on an user authenticated by the vehicle number in a parking lot according to the present disclosure can reduce unnecessary waste of time and physical strength while parking in a building around a destination building desired by the user only with the existing parking lot without more establishing a parking lot.

Further, in a service sharing the micro-mobility, it is possible to reduce the concern of the loss of a micro-mobility device by clear user authentication, increase a recovery rate, and make battery charging easier.

Further, in using the micro-mobility, both users and share operators can conveniently operate and use the system with a convenient charging system, and in addition, an optimized system in terms of a distance and a cost can be provided.

The effects according to the embodiments of the present disclosure are not limited by the contents exemplified above, and more various effects are included in the present specification.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a schematic conceptual diagram of a micro-mobility sharing service system according to an embodiment of the present disclosure.

FIG. 2 is a schematic conceptual diagram of a micro-mobility sharing service system according to another embodiment of the present disclosure.

FIG. 3 is a schematic conceptual diagram of a micro-mobility sharing service system according to another embodiment of the present disclosure.

FIG. 4 is a schematic conceptual diagram illustrating transmission and reception of information between components of a micro-mobility sharing service system according to an embodiment of the present disclosure.

FIG. 5 is a schematic flowchart illustrating a micro-mobility sharing service system according to an embodiment of the present disclosure.

### DETAILED DESCRIPTION

The advantages and features of the present disclosure and a method of achieving them will become apparent with reference to the embodiments described in detail below together with the accompanying drawings. However, it should be understood that the present disclosure is not limited to the embodiments described below, but may be implemented in various other forms and the embodiments are provided so that the disclosure of the present disclosure is fully complete and that those skilled in the art will fully appreciate the scope of the disclosure, and the present disclosure is defined by only the scope of the claims.

Although first and second are used for describing various elements, these elements are not limited by these terms. These terms are used for only distinguishing one component from another component. Therefore, a first component described below may be a second component within the scope of the present disclosure.

Further, the singular form includes the plural form unless otherwise specified in the phrase. As used herein, [symbol] comprises [symbol] and/or [symbol] comprising [symbol] does not exclude the presence or addition of one or more other components other than the described components. Unless otherwise defined, all terms including technical and scientific terms used in the present specification may be used as meanings commonly understood by a person having ordinary skill in the art to which the present disclosure pertains. In addition, terms defined in the commonly used dictionary are not ideally or excessively interpreted unless specifically defined.

Hereinafter, an embodiment of the present disclosure will be described in detail with reference to the attached drawings.

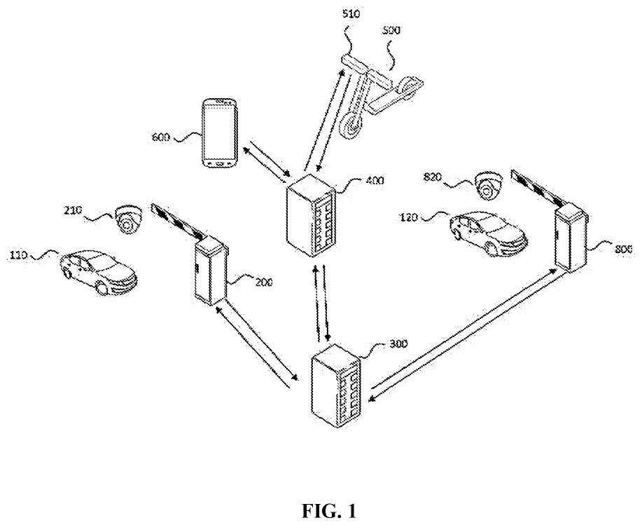

FIG. 1 is a schematic conceptual diagram of a micro-mobility sharing service system according to an embodiment of the present disclosure.

Referring to FIG. 1, the micro-mobility sharing service system located inside a parking lot based on information of a vehicle entering the parking lot according to an embodiment of the present disclosure includes an entering vehicle number recognition system 200 including a first camera 210 for photographing a license plate of an entering vehicle 110 passing through a crossing gate for vehicles entering the parking lot and a number recognition module (not shown) for recognizing characters among images taken by the first camera 210, a management server 300 for receiving and storing entering vehicle number information recognized by the entering vehicle number recognition system 200, a rental server 400 for receiving the entering vehicle number information from the management server 300 and transmitting available micro-mobility information to a user terminal 600 of the entered vehicle 110 based on the entering vehicle number information, and a micro-mobility controller 510 for transmitting information of a first micro-mobility 500 selected by a user based on the received available micro-mobility information to the rental server 400 and receiving use authority information from the rental server 400 received the first micro-mobility information.

The entering vehicle number recognition system 200 photographs a license plate of the entering vehicle 110 through the first camera 210, and information of the photographed license plate is sent to a number recognition module (not shown) to recognize a character. The management server 300 receives and stores the entered vehicle number information recognized by the entering vehicle number recognition system 200. Further, the rental server 400 receives the entered vehicle number information and transmits available micro-mobility information to the user terminal 600 of the entered vehicle 110 based on the entered vehicle number information. Thereby, the user selects the first micro-mobility 500 based on the received available micro-mobility information and again transmits the selected first micro-mobility information to the rental server 400, and the micro-mobility controller 510 receives use authority information from the rental server 400. The micro-mobility controller 510 has permission to use the first micro-mobility 500 by the use authority information to be in an unlocked state, and the user may use the first micro-mobility 500.

In other words, when the micro-mobility controller 510 receives use authority information from the rental server 400, the micro-mobility controller 510 allows an operation of the specific first micro-mobility 500. It will be understood that the meaning that the micro-mobility controller 510 allows the operation of the micro-mobility 500 means that the micro-mobility 500 is systemically or physically unlocked in order to enable the micro-mobility 500 to operate.

The system according to the present disclosure receives use authority information based on the entering vehicle number information of the entering vehicle 110, thereby renting the first micro-mobility 500 existing in the parking lot.

There are a plurality of micro-mobilities in the parking lot, and the micro-mobilities may be rented and returned. In the parking lot, there may basically be remaining space, and recently, various services such as vehicle maintenance and car washing have been provided according to the vehicle user, and the plurality of micromobilities may be provided in one space and a shared service may be provided. The parking lot is generally a part of a building, may provide a space, and in the parking lot, a charging system is well equipped and thus the micro-mobility may be very easily charged, whereby charging can be easily performed without a large cost or a charging system.

It may be characterized that the micro-mobility includes an electric kickboard, a bicycle, an electric scooter, a miniature electric vehicle, a hover board or an electric wheel. The micro-mobility may be small and be easily carried, has a high speed, and be very efficient for short-distance or medium-distance movement because there are few restrictions on a moving environment.

The micro-mobility sharing service system of the present disclosure may share micro-mobilities based on a parking lot. Thereby, when it is difficult for a user to park in a desired destination building, when there is no parking space in the building, or when the excessive parking fee is charged in the building, by parking in a nearby building or a building with a low parking fee and by moving conveniently and quickly to the desired destination using the micro-mobility existing in the corresponding parking lot, a remarkably insufficient parking lot shortage phenomenon can be very effectively solved. That is, by providing a micro-mobility sharing service based on a parking lot, parking a vehicle in a parking lot of another building located at a short distance, renting the micro-mobility in the building and moving to the destination building (after moving, the corresponding micro-mobility may be carried and entered to the building.), the parking problem can be solved and travel time and physical strength consumption can be minimized. The system of the present disclosure can not only share micro-mobility, but also realistically share a parking lot.

In the conventional case, a radius covered by a parking lot in a specific location is generally within a distance of 1 km, but according to the present disclosure, a radius covered by one parking lot may be extended to about 3 to 5 km and thus even a small parking lot can secure a large coverage radius.

The rental server 400 may manage rental and return of a number of micromobilities in connection with the management server 300 and determine the overall status of micro-mobility such as a currently existing micro-mobility, a rented micro-mobility, whether the micro-mobility is charged and discharged, and whether use of the micro-mobility is allowed.

The system of the present disclosure may determine whether to rent the first micro-mobility 500 selected by the user based on the vehicle number to efficiently perform rental, return, and management of the micro-mobility. In the case of the existing micro-mobility sharing service, a user should search for the device while viewing a global positioning system (GPS), and a provider of the sharing service has many problems of device loss and device recovery and thus maintenance and management costs increase, whereby it was difficult to generally manage a sharing micro-mobility.

However, as the system of the present disclosure provides a micro-mobility sharing service in the conventional parking lot, an infrastructure is already provided in the parking lot and thus the battery can be easily charged. In addition, because rental of the micro-mobility is allowed based on the entered vehicle number, in order for an owner of a vehicle in which rental of the micro-mobility is ended to take out the vehicle, the micro-mobility should be essentially returned and cost payment should be preceded and thus the problem of device loss and device return can be solved by itself. Therefore, maintenance of the micro-mobility device is very easy (substantially, the device may be forced to be automatically returned), and maintenance costs can be significantly reduced.

The micro-mobility controller 510 may be coupled to the first micro-mobility 500. That is, as illustrated in FIG. 1, the micro-mobility controller 510 may be mounted in a portion of the first micro-mobility 500. Thereby, the micro-mobility controller 510 may determine whether the first micro-mobility 500 may be used systemically or physically, and the micro-mobility 500 may be used only when use authority information is received. Further, the first micro-mobility 500 may be charged by a charging system (not shown) provided in the parking lot, and the micro-mobility controller 510 may be separated from the charging system (not shown) based on the received use authority information. Further, by measuring a time separated from the charging system (not shown) and a time reconnected to the charging system (not shown) and transmitting the times to the rental server 400 or the management server 300, a use time may be used for cost payment.

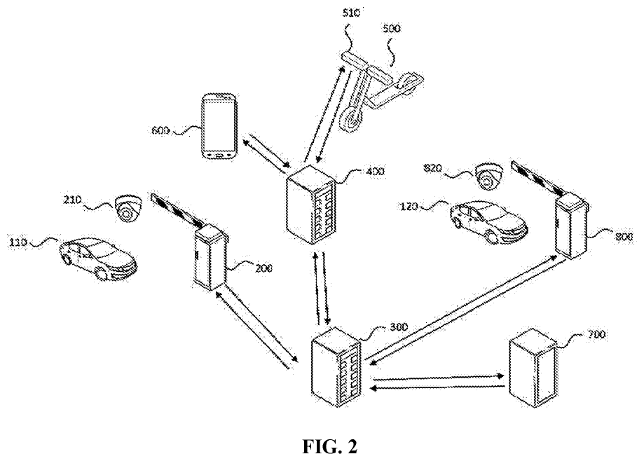

FIG. 2 is a schematic conceptual diagram of a micro-mobility sharing service system according to another embodiment of the present disclosure.

Referring to FIG. 2, the micro-mobility sharing service system according to another embodiment of the present disclosure further includes a cost payment device 700, and when a user completes use of the first micro-mobility 500 and returns the first micro-mobility 500, the micro-mobility controller 510 transmits use completion information to the rental server 400, the rental server 400 transmits use time information of the first micro-mobility 500 to the management server 300, the management server 300 generates first charging information in proportion to the received use time information and transmits the first charging information to the cost payment device 700, and the cost payment device 700 displays the transmitted first charging information, but it may be characterized in that the first charging information may be determined when the user inputs the entering vehicle information. The entering vehicle information may be input through the cost payment device 700.

Further, the management server 300 generates second charging information for a use cost of the parking lot when the user inputs an existing vehicle scheduled time and transmits third charging information obtained by adding the first charging information and the second charging information to the cost payment device 700, and the cost payment device 700 displays the third charging information, and the third charging information may be determined when the user inputs the entering vehicle information, and the entering vehicle information may be input through the cost payment device 700. Thereby, the parking fee and the micro-mobility rental fee (first charging information) can be together paid, and a recovery rate of the micro-mobility can be maximized.

The micro-mobility sharing service system further includes an exiting vehicle number recognition system 800 including a second camera 820 for photographing a license plate of an exiting vehicle 120 passing through a crossing gate for exiting vehicles of the parking lot and a number recognition module for recognizing characters among images taken by the second camera 820, the micro-mobility sharing service system transmits exiting vehicle number information recognized by the exiting vehicle number recognition system 800 to the management server 300, and when cost payment for the third charging information is completed, the cost payment device 700 transmits payment completion information including the entering vehicle information to the management server 300, and when the exiting vehicle number information and the entering vehicle information of the payment completion information are matched, it may be characterized in that the management server 300 transmits an open command of the exiting vehicle crossing gate to the exiting vehicle crossing gate. Thereby, when matching is performed while satisfying all of the entering vehicle information and the payment completion information and the exiting vehicle information, by enabling the vehicle to leave, vehicles can be released only when all payments for a parking fee and a micro-mobility rental fee are made.

When only one of the first charging information and the second charging information is paid, the cost payment device 700 transmits partial payment completion information including the entering vehicle information to the management server 300, and when the exiting vehicle number information and the entering vehicle information of the partial payment completion information is matched, the management server 300 transmits an open command of the exiting vehicle crossing gate to the exiting vehicle crossing gate, but stores the partial payment completion information to the management server 300, and when a partially paid vehicle uses a second parking lot, the management server 300 may generate first-1 charging information by further charging the first charging information at a first rate. That is, the partial payment completion information represents a case where only a portion of the fees is paid, and even if some borrowers have not paid all expenses, it is allowed to take out a vehicle, but by allowing the some borrowers to pay more in the future, a penalty may be given and long waiting damage of other waiting vehicles can be reduced.

Because the management server 300 may store information of various parking lots to which the system is applied, users who use the parking lot to which the system is applied should pay more in the future, and a delay phenomenon of the exiting vehicle can be effectively prevented.

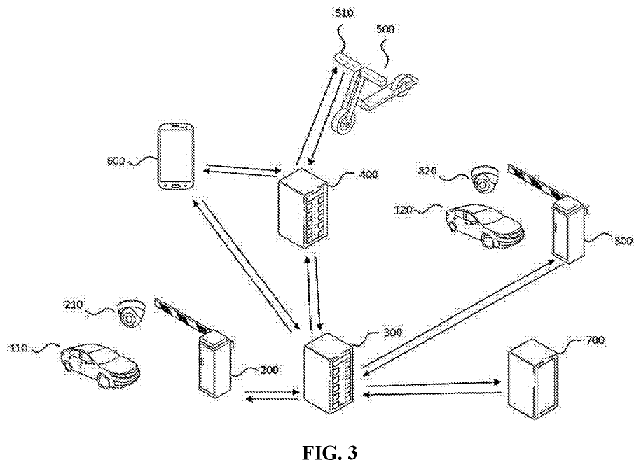

FIG. 3 is a schematic conceptual diagram of a micro-mobility sharing service system according to another embodiment of the present disclosure.

Referring to FIG. 3, the micro-mobility sharing service system further includes a user information input device for enabling a user to input user information including vehicle number and phone number information, the user information input device transmits the input user information to the rental server 400, and the rental server 400 transmits available micro-mobility information to the user terminal 600 of the entered vehicle based on the entered vehicle information received from the management server 300 and the input user information. The user information input device may pay the rental service and the parking fee in order to a borrower of a vehicle using a rental service of the micro-mobility to use the rental service and to determine and pay charged information of the rental service that has been used. The user information input device may be a device separately installed in the parking lot, but it is not limited thereto, and may be the user terminal 600, as shown in FIG. 3.

In order to rent the micro-mobility, the micro-mobility sharing service system further includes a micro-mobility rental application installed in the user terminal 600, and the user inputs personal information including the user's name, phone number, and vehicle number to the micro-mobility rental application, the personal information is transmitted to the management server 300, and the management server 300 receives entering vehicle number information recognized by the entering vehicle number recognition system 200, and transmits authorization information on whether to rent a micro-mobility to the user terminal 600 based on the phone number of the vehicle number matched to the personal information. That is, the management server 300 determines whether personal information input by the user and the entering vehicle number recognized by the entering vehicle number recognition system 200 are matched, if personal information input by the user and the entering vehicle number recognized by the entering vehicle number recognition system 200 are matched, a user is recognized as a normal user, and the management server 300 may transmit authority information on whether to rent the micro-mobility.

In this way, identification of a person who wants to use the micro-mobility rental service may be performed more thoroughly through matching of personal information including a name, phone number, and vehicle number input by the user and entering vehicle number information actually recognized by the entering vehicle number recognition system 200. Thereby, for example, an act of using the micro-mobility rental service by entering a vehicle number of another person (i.e., stealing the vehicle number of another person) may be blocked, and more accurately, the user may be identified, the use fee can be charged, and the device can be recovered and managed. The micro-mobility rental application may be subscribed with approval of an manager in advance, and in this case, the user may input and store in advance personal information including the user's name, phone number, and vehicle number to store the personal information at the management server 300.

The micro-mobility rental application receives preference information including destination information, distance weight information, and cost weight information from a user and transmits the preference information to the management server 300, and the management server 300 transmits micro-mobility rental possible information and parking lot information near a user destination to the micro-mobility rental application of the user terminal 600 based on the preference information. Further, the management server 300 stores parking fee information about a plurality of parking lots, and when the user inputs the preference information, micro-mobility rental estimated time, and estimated parking time information, the management server 300 transmits parking lot information near the user's destination, estimated charging information, and micro-mobility rental possible information to the micro-mobility rental application based on the information.

In the case of a user using the micro-mobility rental service, the degree of preference may be different according to the user's preference. For example, for destination information, there may be a user who prefers a parking lot at a nearby distance or a user who prefers a low-cost place, and in this case, by transmitting the nearby parking lot information and micro-mobility rental possible information to the user terminal 600 by calculating according to the weight input according to the taste of each user, information optimized for the user's taste can be provided. Further, when the user inputs the preference information, the micro-mobility rental estimated time, and the estimated parking time information, the optimized result of the input information may be transmitted to the user terminal 600, and in the case of a parking fee, the cost system varies depending on the use time zone and the cost may be different depending on a use time, and thus information optimized for a micro-mobility rental estimated time and an estimated parking time may be provided to the user.

The user includes a first user who rents a first micro-mobility and a second user who rents a second micro-mobility, and when the first user inputs first movement information including first departure point information, first destination information, first departure scheduled time information, and first destination arrival scheduled time information to the micro-mobility rental application, the first movement information is transmitted to the management server 300, and when the second user inputs second movement information including second departure point information, second destination information, second departure scheduled time information, and second destination arrival scheduled time information to the micro-mobility rental application, the second movement information is transmitted to the management server 300, the management server 300 compares the first movement information and the second movement information, and if the first departure point information and the second destination information, the first departure scheduled time information and the second destination arrival scheduled time information is matched, or if the second departure point information and the first destination information and the second departure scheduled time information and the first destination arrival scheduled time information is matched, the first movement information is transmitted to the user terminal 600 of the second user, the second movement information is transmitted to the user terminal 600 of the first user for exchange, but when the second user exchanges the first micro mobility and the first user exchanges the second mobility, the first user and the second user may transmit exchange execution information to the management server 300 through the micro-mobility rental application.

When different users rent different micro-mobilities at different locations, if destinations and departure points are matched, rented micro-mobilities may be exchanged at corresponding locations. That is, the first user and the second user may want only one-way rental rather than micro-mobility rental for round trips. That is, the first user and the second user want to move quickly and conveniently only until they reach the respective first and second destinations, and they may not want the long-term rental of micro-mobility at destinations thereof. When the destination, the departure point, and the time zone are matched, the users may input the corresponding information, and the management server 300 automatically matches the information and transmits the information to the user terminal of each user and thus the rented micromobilities may be exchanged. Thereby, the first user and the second user pay only one-way costs and do not spend unnecessary expenses, and while the manager charges a cost to each user, the first micro-mobility and the second micro-mobility are returned to original positions thereof and thus there is no disruption in an operation of the system, whereby both the user and the manager can satisfy in a very efficient system operation.

It may be characterized in that the management server 300 transmits the exchange execution information to the rental server 400, wherein the exchange execution information includes exchange time information at which exchange was performed, and when the exchange execution information is transmitted to the management server 300, it may be characterized in that charging information of the first user and the second user is changed based on the exchange time information. Accordingly, the first user and the second user may pay the cost only for the above-described one-way rental charging.

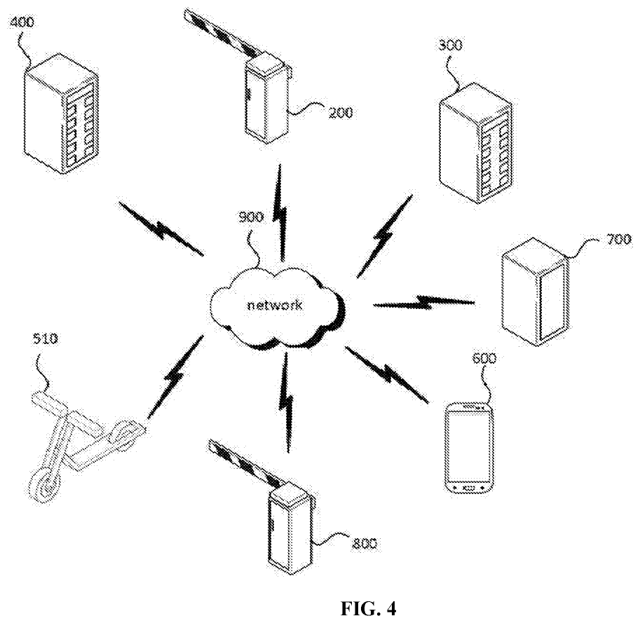

FIG. 4 is a schematic conceptual diagram illustrating transmission and reception of information between components of a micro-mobility sharing service system based on a parking lot according to an embodiment of the present disclosure.

Referring to FIG. 4, a communication network 900 may be an infrastructure for providing wired communication and/or wireless communication between an entering vehicle number recognition system 200, a management server 300, a rental server 400, a micro-mobility controller 510, a user terminal 600, a cost payment device 700, and an exiting vehicle number recognition system 800. The communication network 900 may be configured to include at least one of a mobile communication network such as code division multiple access (CDMA), wideband code division multiple access (WCDMA), high speed packet access (HSPA), and long term evolution (LTE), a wired communication network such as Ethernet, x Digital Subscriber Line (xDSL), Hybrid Fiber Coax (HFC), and Fiber To The Home (FTTH), and a short-range wireless communication network such as Wi-Fi, Wibro, or WiMAX, but the present disclosure is not limited thereto.

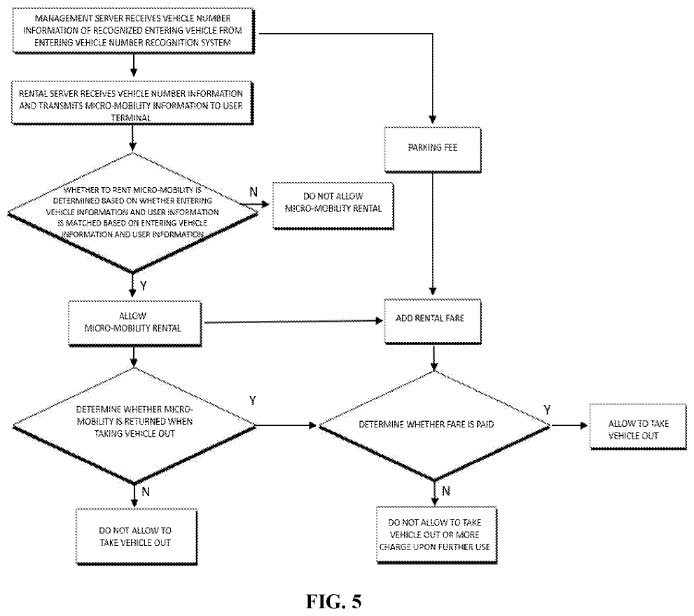

FIG. 5 is a schematic flowchart illustrating a micro-mobility sharing service system according to an embodiment of the present disclosure.

Referring to FIG. 5, the micro-mobility sharing service system of the present disclosure will be described in more detail. First, when a vehicle owner enters a building, a management server receives vehicle number information of an entering vehicle recognized by a first camera and a number recognition module of an entering vehicle number recognition system, and a rental server receives the vehicle number information and transmits micro-mobility information available for rental to a user terminal. Whether to rent the micro-mobility is determined according to whether the entering vehicle information and the user information are matched based on entering vehicle information and user information, and if the entering vehicle information and the user information are not matched, rental of the micro-mobility is disallowed and if the entering vehicle information and the user information are matched, rental is allowed.

When micro-mobility rental is allowed, it is determined whether the rented micro-mobility is returned when taking out the vehicle, and if the rented micro-mobility is not returned, it is not allowed to take out the vehicle and thus the micro-mobility device can be more effectively returned. If return of micro-mobility is determined when taking out the vehicle, a procedure for determining fare payment is then performed. In this case, charging information for a parking lot use time and charging information for a micro-mobility rental use time may be added by the parking management system, and if the fare is not paid, it is not allowed to take the vehicle out or it may be further charged upon further use. Conversely, if fare payment is determined, it may be allowed to take the vehicle out. Thereby, not only parking fee payment, but also micro-mobility rental fee payment can be performed smoothly and thus the rental fee can be effectively prevented from being not paid, and the user can pay the cost by himself.

While the present disclosure has been described with reference to embodiments, the embodiments are only an illustration and do not limit the present disclosure, and it will be understood by those skilled in the art that various changes in form and details may be made therein without departing from the spirit and scope of the disclosure as defined by the appended claims.

For example, each component specifically shown in the embodiments can be modified and implemented. It is to be understood that such variations and applications are to be construed as being included within the scope of the present disclosure as defined by the appended claims.

Further, each component on a configuration diagram or a block diagram of the accompanying drawings may be implemented by software or hardware such as a field-programmable gate array (FPGA) or an application specific integrated circuit (ASIC). However, each component on the configuration diagram or the block diagram may be implemented in an addressable storage medium as well as software and hardware, and may be configured to execute one or more processors.

Each component on a configuration diagram or a block diagram may mean a part of a module, segment, or code including one or more executable instructions for executing a specified logic function. Accordingly, functions provided by components on the configuration diagram or the block diagram may be implemented by a plurality of subdivided components, or a plurality of components on the configuration diagram or the block diagram may be implemented by an integral single component.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A micro-mobility sharing service system located in a parking lot based on information of a vehicle entering the parking lot, the micro-mobility sharing service system comprising:
an entering vehicle number recognition system comprising a first camera for photographing a license plate of an entering vehicle passing through an entering vehicle crossing gate of the parking lot and a number recognition module for recognizing a character among images taken by the first camera;
a management server for receiving and storing entering vehicle number information recognized by the entering vehicle number recognition system;
a rental server for receiving the entering vehicle number information from the management server and transmitting available micro-mobility information to a user terminal of the entering vehicle based on the entering vehicle number information; and
a micro-mobility controller for transmitting information about a first micro-mobility selected by a user based on the received available micro-mobility information to the rental server and receiving uses authority information from the rental server received the first micro-mobility information.

2. The micro-mobility sharing service system of claim 1,
further comprising a cost payment device,
wherein the micro-mobility controller transmits use completion information to the rental server, when the user completes use of the first micro-mobility and returns the first micro-mobility,
the rental server transmits use time information of the first micro-mobility to the management server,
the management server generates first charging information in proportion to the received use time information and transmits the first charging information to the cost payment device,
the cost payment device displays the transmitted first charging information, and
the first charging information can be determined when the user inputs the entering vehicle number information.

3. The micro-mobility sharing service system of claim 2, wherein the management server generates second charging information for a use cost of the parking lot when the user inputs an exiting vehicle scheduled time and transmits third charging information obtained by adding the first charging information and the second charging information to the cost payment device,
the cost payment device displays the third charging information, and
the third charging information can be determined when the user inputs the entering vehicle number information.

4. The micro-mobility sharing service system of claim 3, further comprising an exiting vehicle number recognition system comprising a second camera for photographing a license plate of an exiting vehicle passing through an exiting vehicle crossing gate in the parking lot and a number recognition module for recognizing a character among images taken by the second camera,
wherein exiting vehicle number information recognized by the exiting vehicle number recognition system is transmitted to the management server,
the cost payment device transmits payment completion information comprising the entering vehicle number information to the management server, when cost payment for the third charging information is completed, and
the management server transmits an open command of an exiting vehicle crossing gate to the exiting vehicle crossing gate, if the exiting vehicle number information and the entering vehicle number information of the payment completion information are matched.

5. The micro-mobility sharing service system of claim 4, wherein, when only one of the first charging information and the second charging information is paid, the cost payment device transmits partial payment completion information comprising the entering vehicle number information to the management server,
when the exiting vehicle number information and the entering vehicle number information of the partial payment completion information are matched, the management server transmits an open command of the exiting vehicle crossing gate to the exiting vehicle crossing gate, and
the partial payment completion information is stored at the management server, and when the partially paid vehicle uses a second parking lot, the first charging information is further charged at a first rate to generate first-1 charging information.

6. The micro-mobility sharing service system of claim 1, further comprising a user information input device for enabling the user to input user information comprising vehicle number and phone number information,
wherein the user information input device transmits the input user information to the rental server, and
the rental server transmits available micro-mobility information to a user terminal of the entering vehicle based on the entered vehicle number information received from the management server and the input user information.

7. The micro-mobility sharing service system of claim 1, further comprising a micro-mobility rental application installed in the user terminal in order to rent the micro-mobility,
wherein the user inputs personal information comprising a user's name, phone number, and vehicle number to the micro-mobility rental application, and the personal information is transmitted to the management server, and
the management server receives the recognized vehicle number information from the vehicle number recognition system and transmits authority information on whether to rent the micro-mobility to the user terminal based on the phone number of the vehicle number matched to the personal information.

8. The micro-mobility sharing service system of claim 7, wherein the micro-mobility rental application receives preference information comprising destination information, distance weight information, and cost weight information from the user and transmits the preference information to the management server, and
the management server transmits micro-mobility rental possible information and parking lot information near the user's destination information to the micro-mobility rental application of the user terminal based on the preference information.

9. The micro-mobility sharing service system of claim 8, wherein the management server stores parking fee information about a plurality of parking lots, and
when the user inputs the preference information, a micro-mobility rental estimated time, and estimated parking time information, the management server transmits parking lot information near the user's destination information, estimated charging information, and micro-mobility rental possible information to the micro-mobility rental application based on the information.

10. The micro-mobility sharing service system of claim 7, wherein the user comprises a first user who rents a first micro-mobility and a second user who rents a second micro-mobility,
when the first user inputs first movement information comprising first departure point information, first destination information, first departure scheduled time information, and first destination arrival scheduled time information to the micro-mobility rental application, the first movement information is transmitted to the management server,
when the second user inputs second mobility information comprising second departure point information, second destination information, second departure scheduled time information, and second destination arrival scheduled time information to the micro-mobility rental application, the second movement information is transmitted to the management server,
the management server compares the first movement information and the second movement information, and transmits the first movement information to a user terminal of the second user and transmits the second movement information to a user terminal of the first user for exchange, when the first departure point information and the second destination information, and the first departure scheduled time information and the second destination arrival scheduled time information are matched or when the second departure point information and the first destination information and the second departure scheduled time information and the first destination arrival scheduled time information are matched, and
when the first micro-mobility is exchanged by the second user and the second micro-mobility is exchanged by the first user, the first user and the second user transmit exchange execution information to the management server through the micro-mobility rental application.

11. The micro-mobility sharing service system of claim 10, wherein the management server transmits the exchange execution information to the rental server.

12. The micro-mobility sharing service system of claim 10, wherein the exchange execution information comprises exchange time information in which exchange is performed, and when the exchange execution information is transmitted to the management server, charging information of the first user and the second user is changed based on the exchange time information.
